(19) United States
(12) Patent Application Publication
(10) Pub. No.: US 2013/0108993 A1
(43) Pub. Date: May 2, 2013

(54) METHOD AND SYSTEM FOR SCORING A DIET

(71) Applicant: GRIFFIN HOSPITAL, Derby, CT (US)

(72) Inventor: David L. Katz, Hamden, CT (US)

(73) Assignee: GRIFFIN HOSPITAL, Derby, CT (US)

(21) Appl. No.: 13/661,370

(22) Filed: Oct. 26, 2012

Related U.S. Application Data
(60) Provisional application No. 61/552,598, filed on Oct. 28, 2011.

(51) Int. Cl. G09B 19/00

(52) U.S. Cl. 434/127

(57) ABSTRACT

A method for evaluating a diet includes the steps of: inputting information about a plurality of individual foods forming the diet being evaluated into at least one of a computer and a database; evaluating the diet by measuring the quality of the individual foods forming the diet and compiling scores for each of said measured individual foods to generate an overall score for the diet, wherein the evaluating and compiling step is performed by the computer; and providing information to an individual about overall healthiness of the diet being evaluated.

### CROSS REFERENCE TO RELATED APPLICATION(S)

The instant application claims the benefit of U.S. Provisional Patent Application No. 61/552,598, filed Oct. 28, 2011, entitled METHOD FOR SCORING A DIET, by David L. Katz.

### BACKGROUND

The present disclosure relates to a computer implemented method and system for scoring a diet being consumed by a person to establish whether the diet is healthy or not.

Diet exerts a profound influence on health. An optimal diet can help reduce risk for all major chronic diseases by as much as 80%. Conversely, poor diet is a major underlying cause of chronic disease and premature death.

There is a need for reliable means to measure the nutritional quality of the overall diet in a manner that relates to health outcomes. While there are measurement methods for scoring total diet, none of them are built from measures of quality of individual foods. These measurement methods are based on the pattern of foods, but do not reflect their actual individual quality.

A capacity to measure the nutritional quality of individual foods in a validated manner, and aggregate that into a total diet score, is of great potential to nutrition researchers, policy makers, insurers, employers, clinicians, and individuals seeking to monitor and improve their own diets; however, such a scoring system has not previously existed.

### SUMMARY

The incorporation of a method and a system that can reliably measure the nutritional quality of individual foods into a system that measures the quality of the overall diet is a novel concept.

In accordance with the present disclosure, there is provided a computer implemented method and system for evaluating a particular diet which is being used by, or which may be used by, an individual.

In accordance with the present disclosure, there is provided a method for evaluating a diet which broadly comprises the steps of: inputting information about a plurality of individual foods forming the diet being evaluated into at least one of a computer and a database; evaluating the diet by measuring the quality of the individual foods forming the diet and compiling scores for each of the measured individual foods to generate an overall score for the diet, wherein the evaluating and compiling steps is performed by the computer, and providing information to an individual about overall healthiness of the diet being evaluated.

Further, in accordance with the present disclosure, there is provided a system for scoring a diet which broadly comprises: a computer, a database, an input device and a display device; at least one of the computer and the database containing information about a plurality of individual foods forming the diet being evaluated; the computer being provided with means for evaluating the diet by measuring the quality of the individual foods forming the diet and for compiling scores for each of the measured individual foods to generate an overall score for the diet; and means for providing information about overall healthiness of the diet being evaluated.

Other details of the diet scoring method and system of the present disclosure are set forth in the following detailed description.

### BRIEF DESCRIPTION OF THE DRAWINGS

FIG. 1 is a schematic representation of a system which may be employed to score a diet; and

FIG. 2 is a flowchart showing a method for scoring a diet.

### DETAILED DESCRIPTION

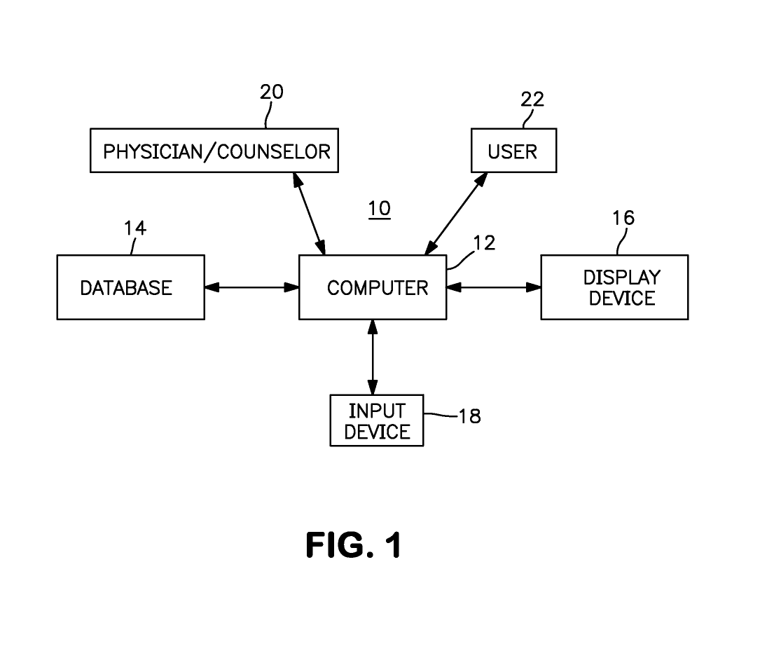

Referring now to FIG. 1, there is shown a system 10 for determining an overall diet score. The system includes a computer or computer processor 12, a database 14 for saving information about the individual, calorie information, and diet scores, a display device 16 for printing out and/or visually observing information about a diet being scored, and an input device 18 such as a keyboard, a CD/DVD disc reader, and a memory unit reader. The system 10 may be used to provide information to or allow access to information by a doctor or counselor 20 or an individual 22. Access to the system 10 may be provided to the physician/counselor and/or to the user via a wireless connection to another computer or computer processor or to a PDA device, such as a smart phone or another hand-held device, being used by the physician/counselor or the user.

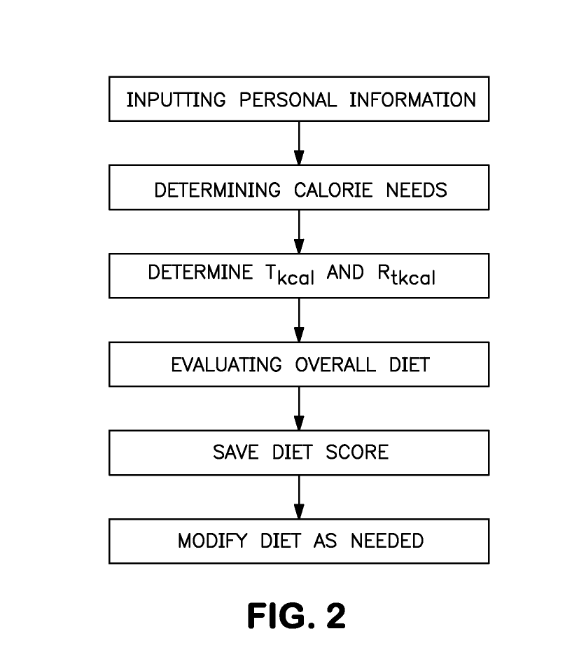

Referring now to FIG. 2, a method for determining the overall diet score for a particular diet may include the steps of inputting into the computer 12 or into the database 14, which may be accessed by the computer 12, personal information about an individual. The personal information may include, but not be limited to, at least one of the individual's name, age, sex, body mass index (BMI) and activity level.

Thereafter, the calorie needs for the individual for a given time period may be determined. The determination may be performed by the computer 12 using a formula, such as the Harris-Benedict or Mifflin-St Jeor formula, with which the computer 12 has been programmed. Thereafter, the total number of calories (T_{kcal}) consumed by that individual for a given time period such as per week and the total recommended calories for that individual (R_{tkcal}) for the given time period may be determined and inputted into the computer 12 and/or stored in the database 14 associated with the computer 12. The foregoing information allows one to adjust the diet quality score for calories. As will be discussed hereinafter, a diet quality score or overall diet score can be generated independent of calorie level if desired.

The overall diet may be evaluated by programming the computer 12 to use an equation which includes a function for total calorie intake. The equation may read as follows:

MEAN_{ONQI}*[Σ{(FC₁₋ᵢ servings/tkcal)/(Rfcᵢ servings/2000kcal)}]*[Σ{(FC₁₋ᵢ servings/Rfc₁₋ᵢ servings)/i}*(N/Yi)*(F+P+C/3)]*R_{tkcal}/T_{cal},

where T_{kcal}=total calories consumed;
where R_{kcal}=total recommended calories for age, sex, BMI, and activity level (e.g. Harris-Benedict or Mifflin-St. Jeor formulas); and
where if R_{tkcal}/T_{kcal}>1.33, one lets R_{tkcal}/T_{kcal}=T_{kcal}/R_{tkcal})

This penalizes both high and low calorie intake, while rewarding calorie intake between 75% and 100% of recommended.

In applying the above equation, it may be assumed that the diet includes two variations of breakfast per week with 3 foods each; two variations of lunch per week with 3 foods each; two variations of snack per week, 1 food each; and 7 variations of dinner per week with 4 foods each. This gives a value for the variety coefficient (Y) of 42. As a result, the value Yi, which is the minimal optimum for number of foods*i (where i=10), may be set to 420.

The value N is the total number of different or distinct foods in recommended Dietary Guidelines (DG) for Americans categories minus all foods in discretionary dietary guideline category or in no category. For example, N may equal 16 distinct foods distributed across 5 DG categories, which equals 80. A food may be defined as the combination of a food name, a food group, and nutrient profile/ONQI score. So, if a food is called spinach and generates nutrient profile X, then any other food called spinach with the same nutrient profile X is the same food. If a food is called SPINACH PLUS and generates nutrient profile Y resulting in a different ONQI score, then it is a distinct food.

The ONQI score may be determined using the ONQI method set forth hereinbelow. The ONQI method is a means of measuring the nutritional quality of individual foods. In order to implement this step of the method, information about each of the individual foods forming the diet being evaluated is inputted into at least one of the computer and the database. As used herein, the term “food” includes a single item of food or a dish made from one or more foods. The overall diet scoring method and system described herein is unique in that it measures the quality of the individual food forming the diet by generating the ONQI scores. The scores are then compiled and used to generate the overall score for the diet. The computer 12 may be programmed to perform the evaluation and compiling steps.

The overall nutrition quality index (ONQI) is designed to generate an objective measure of overall nutritional quality based on the way a food product influences the trajectory of a diet. For purposes of this application, the word “trajectory” may be defined as follows—if a minimal intake level of a given nutrient, e.g. calcium, is recommended each day in a prototypical 2000 kcal diet, a food product providing a more concentrated dose of that nutrient/calorie than is recommended over the course of the day will assist in meeting the recommendation, and thus has a favorable influence on dietary trajectory. The overall nutritional quality index will reward such an influence. If a maximal intake level of a given nutrient, e.g. sodium, is recommended each day in a prototypical 2000 kcal diet, a food product providing a more concentrated dose of that nutrient/calories than is recommended over the course of the day will contribute toward excessive consumption, and thus has a negative influence on the dietary trajectory. The overall nutritional quality index will punish such influences as reflected in lower scores for overall nutritional quality.

TABLE 1
Nutrients Selected

| | | Universal |
|---|---|---|
| Numer. Nutrients | Denom. Nutrients | Adjustors Nutrients |
| Fiber | Saturated Fat | Healthy Fatty Acids |
| Folate | Trans Fat | Biological- |
| | | Quality of Protein |
| Vitamin A | Sodium | Energy Density |
| Vitamin C | Sugar | Glycemic Load |
| Vitamin D | Cholesterol | |
| Vitamin E | | |
| Vitamin B12 | | |
| Vitamin B6 | | |
| Potassium | | |
| Calcium | | |
| Zinc | | |
| Omega-3 fatty acids | | |
| Total bioflavanoids | | |
| Total carotenoids | | |
| Magnesium | | |
| Iron | | |

A trajectory score (TS) is created for each of the selected nutrients. The trajectory score is the amount of each nutrient per calorie in the food item, adjusted to the recommended intake (see threshold values) of the nutrient. 1 is added to the total calorie to all items. This helps avoid infinite numbers when creating trajectory scores for items with no calorie.

Example of TS for calcium in milk, 1% fat or lowfat;

$$\begin{matrix}TS = amount of calcium / energy / recommended intake of calcium \\ = 119 / 43 / 0.5455 \\ = 5.1\end{matrix}$$

Trajectory scores are log transformed to compress the scores and correct for unequal variations of the trajectory scores of nutrients.

Example of log transformed TS for calcium in milk, 1% fat or lowfat;

Log of(1+TS)=log(1+5.1)=1.8

Note: 1 is added to the TS before the log transformation to avoid invalid number (i.e. zero) for the log function. By adding 1 before the log transformation makes it such that if the TS equal zero (i.e. none contributing), it will still be zero or none contributing after log transformation of the TS. Adding 1 before log transformation also help avoid negative number in situation where the TS<1.

The harmful nutrients contribute to the denominator only when the amount of the nutrient per calorie, exceed the recommended intake i.e., contributions below the threshold level are ignored.

Numerator nutrients are valued for contributing toward the recommended intake.

Nutrients are given added value points for exceeding the recommended intake.

Nutrients considered harmful or inappropriate in any dose (e.g. trans fat) are penalized from the first unit.

The trajectory score for healthy fatty acids are computed differently from the traditional trajectory score since there are no recommended intakes to date. The trajectory score is calculated as the proportion of calorie of the healthy fatty acids (i.e. monounsaturated and polyunsaturated fatty acids) in total fat calorie in the food (i.e. [MUFA calorie+PUFA calorie+1]/total fat calorie).

The threshold values for the nutrients used in the algorithm are per 2000 calories. The majority of threshold values for the numerator nutrients are selected based on the suggestions of the Committee on Use of Dietary Reference Intakes in Nutrition Labeling, Food and Nutrition Board, as presented in Dietary Reference Intakes: Guiding Principles for Nutrition Labeling and Fortification. Threshold values for which no recommendations were made are potassium, total carotenoids, protein, and B6.

The RDA for potassium for males and females greater than 14 years of age is 4.7 grams per day. Since there is no evidence of adverse effects has been demonstrated from food intakes, so no upper limit was set. Based on these facts, the RDA of potassium per 2000 kcal was set at 4.7 g.

If the variety of fruits and vegetables were consumed following the U.S. Diet ˜5.2 to 6.0 mg of provitamin A carotenoids would be consumed. Approximately 9 to 18 mg/day of carotenoids would be consumed by following other food based patterns recommended for the prevention of cancer and other chronic diseases.

Using the reference weight (i.e. 63.5 kg), and assuming a 2000 calories intake for a 63.5 kg individual, the threshold value for protein is 50.8 g protein per day, or 0.0254 g protein per kcal.

The upper limit of vitamin B6 is set at 100 mg/d for adults and 30 to 80 mg/day for children. Since this level is only reachable via supplementation, and the mentioned benefit to homocysteine levels, the RDA per 2000 calories was set at 1.7 mg.

Threshold values for the denominator nutrients are selected based on the previous US-RDA's for cholesterol, sodium, and saturated fat. The level for added sugar is based on the recommended amount of discretionary calories in a 2000 calorie diet set forth by the Dietary Guidelines Advisory Committee on Dietary Guidelines for Americans 2005. Since there are no health benefits attributable to the consumption of trans fat and gram for gram, industrially produced trans fatty acids appear to have an adverse effect on the development of heart disease that is more than 10 times greater than that of saturated fat, the threshold value was set at 1 mg.

TABLE 2
Threshold Values for Nutrients in the Algorithm

| Nutrients | Threshold Values |
|---|---|
| Numerator Nutrients | |
| Fiber | 0.014 |
| Folate | 0.157 |
| Vitamin A | 0.2645 |
| Vitamin C | 0.0315 |
| Vitamin D | 0.00345 |
| Vitamin E | 0.006 |
| Vitamin B12 | 0.001 |
| Vitamin B6 | 0.00085 |
| Potassium | 0.00235 |
| Calcium | 0.5455 |
| Zinc | 0.00375 |
| Omega-3 fatty acids | 0.0008 |
| Total bioflavanoids | 0.00759 |
| Total carotenoids | 0.00675 |
| Magnesium | 0.143 |
| Iron | 0.0031 |
| Denominator Nutrients | |
| Saturated Fat | 0.01 |
| Trans Fat | 0.0005 |
| Sodium | 1.2 |
| Sugar | 0.1335 |
| Cholesterol | 0.15 |
| Universal Adjustors | |
| Healthy Fatty Acids | — |
| Protein | 0.0254 |

Note: All values are derived using a 2000 kcal prototypical diet, than expressed per kcal.

The log transformed trajectory scores are weighted using the standard weighting coefficients for each of the nutrients. The standard weighting coefficients include measures of prevalence of inadequate intake of nutrients, severity of impact and relative impact. The prevalence of inadequate intake of nutrients was obtained from the National Health and Nutrition Examination Surveys (NHANES). The severity of impact and relative impact determinations were made based on evidence from the literature together with recommendations from the expert panel. The prevalence of inadequate intake of nutrients (W_{P}), severity of impact (W_{S}) and relative impact (W_{R}) were transformed into ordinal scales ranging from 1 to 4, 1 to 3 and 0.25 to 4 respectively. The standard weighing coefficients are designed to capture the epidemiologic relevance of the nutrient with regard to the prevalence and severity of the health condition(s) most influenced by the nutrient, and the strength of the association (relative impact) between a given nutrient and condition (i.e. W_{P}×W_{S}×W_{R}×log(1+TS of the nutrient)). Table 3 shows a complete list of the W_{P}, W_{S} and W_{R} of all the nutrients.

W_{P} is the weighting coefficient for prevalence of impact of inadequate intake of a nutrient. The W_{P} is an ordinal scale ranging from 1 to 4.

W_{P}=1, rare<20% inadequate intake

W_{P}=2, moderate 20-50% inadequate intake

W_{P}=3, common 51-79% inadequate intake

W_{P}=4, very common 80% inadequate intake

W_{S} is the weighting coefficient for strength/severity of impact. The W_{S} is an ordinal scale ranging from 1 to 3.

W_{S}=1, minor severity defined as contributing to pathology but not deliberating or a cause of premature death e.g. seborrheic dermatitis.

W_{S}=2, moderate severity defined as contributing to chronic disability not associated with premature death e.g. osteoporosis, obesity.

W_{S}=3, high severity defined as contributing to premature death from cancer, heart disease, diabetes and stroke.

W_{R} is the relative impact for a nutrient to public health. This is an ordinal scale ranging from 0.25 to 4.

W_{R}=0.25, nutrients with modest impact to public health.

W_{R}=1, no relative impact or if relative impact is uncertain to public health.

W_{R}=2, moderate beneficial relative impact to public health.

W_{R}=4, high beneficial relative impact to public health.

TABLE 3
W_{P}, W_{S}, and W_{R} for Nutrients in the Algorithm

| Nutrients | W_{P} | W_{S} | W_{R} |
|---|---|---|---|
| Numerator Nutrients | | | |
| Fiber | 4 | 3 | 4 |
| Folate | 1 | 3 | 1 |
| Vitamin A | 2 | 1 | 1 |
| Vitamin C | 2 | 2 | 1 |
| Vitamin D | 4 | 3 | 2 |
| Vitamin E | 4 | 3 | 0.25 |
| Vitamin B12 | 1 | 1 | 1 |
| Vitamin B6 | 1 | 1 | 1 |
| Potassium | 4 | 2 | 1 |
| Calcium | 3 | 2 | 1 |
| Zinc | 2 | 1 | 1 |
| Omega-3 fatty acids | 2 | 3 | 4 |
| Total bioflavanoids | 4 | 3 | 1 |
| Total carotenoids | 3 | 3 | 1 |
| Magnesium | 3 | 1 | 1 |
| Iron | 1 | 1 | 1 |
| Denominator Nutrients | | | |
| Saturated Fat | 4 | 3 | 2 |
| Trans Fat | 4 | 3 | 4 |
| Sodium | 4 | 2 | 4 |
| Sugar | 4 | 2 | 1 |
| Cholesterol | 4 | 3 | 0.25 |
| Universal Adjustors | | | |
| Healthy fatty acids | 4 | 3 | 1 |
| Protein | 1 | 1 | 1 |

The log transformed trajectory scores of protein are weighted by the standard weighing coefficients (i.e. W_{P}, W_{S}, and W_{R}) and in addition by the biological quality weighing coefficient (W_{Q}) for protein (i.e. W_{P}×W_{S}×W_{R}×W_{Q}×log(1+TS of protein)). The W_{Q} is determined using a standard formula for the quality of protein based on the distribution of rate-limiting amino acids in a given food. When a protein source contains any of the rate-limiting amino acids and the amounts meet the recommended intake, 0.5 points are awarded to the rate-limiting amino acid (see Table 4.). The sum of points for each rate-limiting amino acid plus 1 represents the biological quality weighing coefficient for the protein in that item. One is added to all W_{Q} so that if protein in an item has none of the rate-limiting amino acids, or the sum of the points earned is equal to zero, the resulting W_{Q} will be unity (N.B.—similar mathematical adjustments are made repeatedly in the ONQI formula to avoid the possibility of 0 ever occurring as a denominator entry, etc.). Since W_{Q} is a multiplier, multiplying the weighted log transformed trajectory score of protein by 1 will have a null effect. Based on these assumptions, the minimum possible W_{Q} score is 1 and the maximum possible W_{Q} score is 5.5. As with all ONQI entries, the validation of this range was based on repeated test runs of the ONQI, the scoring and ranking of foods, and the comparison of the rankings generated to the collective judgment of the nutrition expert panel.

TABLE 4
Rate-limiting Amino Acids and their Recommended Intake

| Rate-limiting | Recommended | Points Earned |
|---|---|---|
| Amino Acids | Intake (RI) | if ≧ RI |
| Isoleucine | 25 mg | 0.5 |
| Leucine | 55 mg | 0.5 |
| Lysine | 51 mg | 0.5 |
| Methoinine & Cysteine | 25 mg | 0.5 |
| Phenyalanine & Tyrosine | 47 mg | 0.5 |
| Threonine | 27 mg | 0.5 |
| Tryptophan | 7 mg | 0.5 |
| Valine | 32 mg | 0.5 |
| Histidine | 18 mg | 0.5 |

Sum of the Numerator and Denominator Nutrients

The weighted log transformed trajectory scores of the numerator nutrients are summed to form an aggregate score for the numerator nutrients. The weighted log transformed trajectory scores of the denominator nutrients are also summed to form an aggregate score for the denominator nutrients. The sum of nutrients is entered as 1+sum of weighted log transformed trajectory scores of numerator nutrients or 1+sum of weighted log transformed trajectory scores of denominator nutrients. The 1 is added so that if the sum equals zero, the resulting value will be unity. This helps to avoid any mathematical anomalies, such as a result of infinity, when dividing the sum of the numerator nutrients by the sum of denominator nutrients; in some foods, the aggregate denominator score would equal zero.

Sodium and sugar are excluded from the denominator of the algorithm for fruits, vegetables, and unprocessed beans, legumes, nuts, and seeds.

The ONQI includes 4 “Universal Adjustors” (UA), coefficients intended to modify the aggregated trajectory scores based on a characteristic of the food item. The two UAs in the numerator adjust for the biological quality of protein, and the quality/nutritiousness of fatty acid distribution. The two in the denominator account for energy density, and glycemic load.

The universal adjustors (UA) in the numerator are the weighted log transformed trajectory scores of healthy fatty acids (UA1) and biological quality of protein (UA2). The universal adjustors are multiplied to the sum of the weighted log transformed trajectory scores of the numerator nutrients. The universal adjustors are entered as 1+UA1 and 1+UA2. 1 is added to the UA so that when the universal adjustors equal zero, the resulting value of universal adjustors will be 1. This will none contributing when multiplied to the sum of the weighted log transformed trajectory score of the numerator nutrients.

The numerator universal adjustors are limited only to items with at least 20 kcal of total energy, at least 10% kcal of total fat and at least 10% kcal of protein. That is when the total kcal of an item is less than 20 or total kcal of fat less than 10, then UA1 is considered zero. When the total kcal of an item is less than 20 or the total kcal of protein less than 10, then UA2 is considered none contributing of zero. These cutoff values that limit universal adjustors' entries are based on the recommended proportions of intake for a healthy diet according to the recent guidelines from the United States government.

The sum of the weighted log transformed trajectory scores of the denominator nutrients are multiplied by the energy density and glycemic load of the item.

The energy density (ED) of each item was entered as 0.5+energy of item/100/9 or 0.5+energy density of item/11.1.

The glycemic load (GL) of each item was entered as 0.5+glycemic load of item/20. Glycemic load values are derived using the NDSR database from the University of Minnesota, and are based on: Foster-Powell K, Holt S H, Brand-Miller J C. International table of glycemic index and glycemic load values: 2002. Am J Clin Nutr. 2002; 76:5-56.

Energy density is excluded from the algorithm for oils.

ONQI FORMULA:

1^{st} Universal Adjustor×2^{nd} Universal Adjustor×Sum of Weighted log transformed TS of Numerator Nutrients

Glycemic Load×Energy Density×Sum of Weighted log transformed TS of Denominator Nutrients

Or

(1+UA1)×(1+UA2)×(1+W_{P1}×W_{S1}×W_{R1}×log(1+TS₁)+ - - - +W_{P16}×W_{S16}×W_{R16}×log(1+TS₁₆))

GL×ED×(1+W_{P1}×W_{S1}×W_{R1}×log(1+TS₁)+ - - - +W_{P5}×W_{S5}×W_{R5}×log(1+TS₅))

### Wherein,

W_{P}=weighting coefficient for prevalence of impact of the nutrient entered
W_{S}=weighting coefficient for strength/severity of impact of the nutrient entered
W_{R}=Relative impact of the nutrient entered
TS=Trajectory score of nutrient entered
UA1=% W_{P} healthy fatty acids×W_{S} healthy fatty acids×W_{R} healthy fatty acids×log(1+TS of healthy fatty acids)
UA2=% W_{P} protein×W_{S} protein×W_{R} protein×W_{Q}×log(1+TS of protein)
ED=0.5+Energy density of item/100/9 or 0.5 Energy density of item 11.1
GL=0.5+Glycemic load of item/20

Food items may be scored using the University of Minnesota Nutrition Data System for Research (NDSR) 2006. The NDSR 2006 consists of over 18,000 generic foods plus 8,000 branded products. It has values for 147 nutrients, nutrient ratios and other food components.

The raw ONQI scores generated by the formula have no intrinsic meaning except relative to one another; they stratify the overall nutritiousness of foods. They allow a consumer to make fair comparisons of food items based on their overall nutritional value, derived from considerations of nutritional biochemistry, basic physiology and metabolism, and epidemiology and public health. On a relative scale, the scores indicate the degree to which the selection of a given food item supports good nutrition and the approximation of a dietary intake pattern concordant with prevailing recommendations (e.g., the 2005 Dietary Guidelines for Americans; the Dietary Reference Intake Ranges of the Institute of Medicine).

The smallest possible scores are less than 1 but greater than zero. The maximum possible score could be a very large finite number. Since the scale is arbitrary, it may be expanded or compressed at will by simple mathematical manipulations, such as conversion to a percentage, or log transformation, etc. A higher score indicates better overall nutritional quality, while a lower score indicates lower overall nutritional quality of an item.

The development of the index included selecting nutrients considered either beneficial or harmful to public health. Nutrients are classified based on whether they are beneficial or harmful. Numerator nutrients are generally considered beneficial, while denominator nutrients are considered likely to be harmful. The selection and classification of nutrients was based on existing evidence in the literature supporting their public health implications. A list of nutrients which may be included in the index is shown in Table 1.

In addition to the numerator and denominator nutrients selected, four macronutrients were also selected and considered universal adjustors nutrients. The macronutrients considered universal adjustors included: the healthy fatty acids (i.e. monounsaturated and polyunsaturated fatty acids), the biological quality of protein, energy density and glycemic load.

One step in utilizing the overall nutrition quality index is to analyze a variety of foods and food products to determine their detailed nutritional composition. This may be done using any suitable technique known in the art. The properties of each food or food product may then be stored in the data base 14 or another database which can be accessed by the computer 12.

To provide an overall nutrition quality index (ONQI) score for each food or food product, the computer 12 may be programmed with the overall nutrition quality index formula described above.

The Mean ONQI is the average of ONQI scores of individual foods weighted by number of servings.

F refers to fat calories, but is a dichotomous dummy variable (1/0) based on whether fat calories do, or don't, fall within Institute of Medicine (IOM) recommended range. F may equal 1 if fat calories/total calories falls within IOM range.

P refers to protein calories, but is a dichotomous dummy variable (1/0) based on whether protein calories do, or don't, fall within Institute of Medicine recommended range. P may equal 1 if protein calories/total calories falls within IOM range.

C refers to carbohydrate calories but is a dichotomous dummy variable (1/0) based on whether carbohydrate calories do, or don't, fall within Institute of Medicine recommended range. C may equal 1 if carbohydrate calories/total calories falls within IOM range.

If F and P and C=0, one can let (F+P+C/3)=1/6. If (F+P+C/3)=1, then one can let (F+P+C)=2, i.e. double the credit for macronutrient distribution when all three macronutrient classes are within IOM ranges.

FC refers to a food category derived from Dietary Guidelines for Americans—current version is 2010.

FC₁₋ᵢ servings equals the total number of food servings in given food category 1 through i.

Rfcᵢ is the recommended servings of given food category per 2000 kcal in dietary guidelines (DG); i refers to any given category from a total list of i distinct food categories. i may range from 1-10.

The equation discussed above includes 6 total functions, which in sequence are:

F1=grand mean of ONQI scores for individual entries. This measures food quality.
F2=proportional contribution of each food category to total diet, measured in servings. This measures pattern quality and moderation.
F3=distribution; the degree to which foods are selected in the several distinct food categories recommended, and the degree to which proportional servings per group meet guidelines.
F4=variety; the total number of unique foods.
F5=balance with regard to macronutrient categories. This measures balance, variety, and distribution/proportionality.
F6=quantity. This measures ratio of actual to recommended calories. Rewards caloric intake between 75% and 100% of recommendation for weight maintenance; penalizes calorie levels both above and below this range.

The operational steps in total diet scoring performed during the evaluation step may be as follows:

obtain nutrient information for an individual food/dish from a database or another source containing same and inputting same into the pre-programmed computer 12;
using the pre-programmed computer 12 to generate a standard ONQI score for each individual food/dish;
use steps 1 and 2 to determine a grand mean ONQI score for total food items (grand mean ONQI score equals the value in step 2/total aggregated servings);
assign each serving (or part of a serving) of any food item or dish to one or more of the categories in the dietary guidelines for which a minimum recommended intake in servings per day is provided (i=10);
determine the total number of servings of food items in each of the categories addressed in step 4;
for each food category addressed in step 4, divide the total number of servings by the total cumulative calorie intake and then divide that by the recommended servings of that food category over 2000 kcal (i.e. recommended servings per day). This step will look like the following:
((##servings/### total calories)/(recommended servings per day of this food category/2000 kcal)). For each food category except vegetables and fruits, if (##servings/### total calories)/(recommended servings per day of this food category/2000 kcal)>1, then let (##servings/### total calories)/(recommended servings per day of this food category/2000 kcal)=1. For each sub-category of vegetables, if (##servings/### total calories)/(recommended servings per day of this food category/2000 kcal)>2, then let (##servings/### total calories)/(recommended servings per day of this food category/2000 kcal)=2. If total for vegetable category (all sub-categories summed)>4, let total for vegetable category=4. For fruit, if (##servings/### total calories)/(recommended servings per day of this food category/2000 kcal)>2, let (##servings/### total calories)/(recommended servings per day of this food category/2000 kcal)=2.
repeat step #6 for each of the food categories in the dietary guidelines (i=10) as defined in #4 above, and then sum them.

For each per-category value generated in step #7, divide that value by the total number of recommended categories i (i=10) and then sum them.

divide the total number of distinct food items by Y;
multiply the value in #8 by the value in #9;
determine the values for F, P, and C as discussed above and determine the value of (F+P+C/3) as discussed above;
multiply the value generated in step #11 by the value generated in step #10;
multiply the value generated in step #12 by the value generated in step #7;
multiply the value generated in step #13 by the value generated in step #3;
the value generated in step #14=ONQI_{tds} where tds stands for total diet scoring; and
multiply the value generated in #15 by the calorie adjustment when available) to generate the caONQItds.

All of steps 1-16 may be carried out by using the computer 12 which has been programmed to carry out each step.

The total or overall diet score may then be saved to the database 14 to be recalled as needed for viewing. The total or overall diet score may be used to modify an individual's diet as needed to accomplish or maintain a desired weight for the individual and/or to achieve or maintain a desired health condition for the individual.

The total or overall diet score for an individual's diet may be printed out and given to the individual as a report. The total or overall diet score may be used by a physician, practitioner, or counselor to counsel an individual on diet as part of a weight loss/control program or as part of some other health program to maintain or modify a health condition.

The total diet score may be adjusted continuously over time as more entries are made into the system 10.

The scoring system 10 may also be used to generate tailored messages for improving the diet of an individual and thereby raising the total diet score. The tailored messages may be accessed by an individual user in an interactive, computer-based environment in which the user has access to the information on the system 10.

The method used herein allows a user to compare one diet against another to determine which one is healthier.

The results displayed in Appendix I are the results of tests of different diets. The data in Appendix I shows that the test diets are stratified and that the calorie-adjusted scores are stratified with 80% of recommended calories scoring the best; 100% and 50% of total recommended calories scoring second best at the same level; and 200% of recommended calories scoring lowest.

While the diet scoring method described hereinabove talks about inputting personal information about an individual into the computer and/or database, this step can be omitted. Without the entry of this information, a diet can be scored by inputting the information about a plurality of individual foods forming the diet being evaluated and then performing the evaluating and compiling steps. The score which is generated is not adjusted for recommended caloric intake.

When the personal information is entered into the computer 12 and/or the database 14, the overall diet score is refined to be made relative to recommended caloric intake for the individual. When body mass index information is provided, scores for lower calorie intake can be revised up when someone is heavy, and down when someone is thin/underweight, and vice versa.

The aggregation of individual ONQIs cores generates an overall diet score that correlates with health outcomes, including all-cause mortality.

There has been described herein a method and system for evaluating or scoring a diet. While the method has been described in the context of a specific embodiment thereof, other unforeseen modifications, variations, and alternatives may become apparent to those skilled in the art. It is intended to embrace those modifications, variations, and alternatives.

What is claimed is:

1. A method for evaluating a diet comprising the steps of:
inputting information about a plurality of individual foods forming the diet being evaluated into at least one of a computer and a database;
evaluating said diet by measuring the quality of the individual foods forming the diet and compiling scores for each of said measured individual foods to generate an overall score for said diet, wherein said evaluating and compiling step is performed by said computer; and
providing information to an individual about overall healthiness of said diet being evaluated.

2. The method of claim 1, wherein said inputting individual food information comprising inputting information about a plurality of foods consumed by an individual for a given time period.

3. The method of claim 2, further comprising:
inputting personal information about said individual into said at least one of a computer and a database; and
determining caloric needs for said individual for said given time period; and
determining a total number of calories consumed by said individual for said given time period.

4. The method of claim 3, further comprising:
determining a total recommended calories for said individual for said given time period; and
inputting caloric information including said determined calorie needs, said determined total number of calories, and said determined total recommend calories into said at least one of said computer and said database.

5. The method of claim 1, further comprising modifying said diet as needed to achieve a desired health condition for said individual.

6. The method of claim 3, wherein said inputting personal information step comprises inputting at least one of age, sex, body mass index, and activity level of said individual.

7. The method of claim 1, wherein said providing information step comprises providing said individual with said overall diet score and generating tailored messages for improving the individual's diet so as to raise the overall diet score.

8. The method of claim 1, further comprising allowing said individual to access said overall diet score using at least one of a user computer and a PDA device.

9. The method of claim 1, wherein said information providing step comprises providing said overall diet score to a health care professional so that said health care professional can counsel said individual on a desired health program.

10. The method of claim 1, further comprising saving said overall diet score on said database.

11. The method of claim 1, wherein said evaluating and compiling step comprises programming said computer to use the following equation:
MEAN_{ONQI}*[Σ{(FC₁₋ᵢ servings/tkcal)/(Rfcᵢ servings/2000kcal)}]*[Σ{(FC₁₋ᵢ servings/Rfc₁₋ᵢ servings)/i}*(N/Yi)*(F+P+C/3)]*R_{tkcal}/T_{cal},
where T_{kcal}=total calories consumed;
where R_{kcal}=total recommended calories for age, sex, BMI, and activity level;
where if R_{tkcal}/T_{kcal}>1.33, one lets R_{tkcal}/T_{kcal} (T_{kcal}/R_{tkcal});
where Mean ONQI is the average of ONQI scores for individual foods weighted by number of servings;
where F refers to fat calories;
where P refers to protein calories;
where C refers to carbohydrate calories
where FC refers to a food category;
where FC₁₋ᵢ servings equals the total number of food servings in a given food category 1 through i;
where Rfcᵢ is the recommended servings of a given food category per 2000 kcal and i refers to any given food category;
where i may range from 1-10; and
where Yᵢ refers to a nutrient profile for a given food.

12. The method of claim 1, wherein said evaluating and compiling step comprises:
(a) obtaining nutrient information for an individual food/dish and inputting said nutrient information into said computer;
(b) generating a standard ONQI score for each individual food/dish;
(c) determining a mean ONQI score for total food items;
(d) assigning each serving of any food item or dish to at least one category in a dietary guideline for which a minimum recommended intake in servings per day is provided;
(e) determining the total number of servings of food items in said at least one category;
(f) for each said at least one category, dividing a total number of servings by a total cumulative calorie intake and then dividing that by the recommended servings of said at least one category over 2000 kcal;
(g) repeat step (f) for each said at least one food category;
(h) for each per category value generated in step (g), divide a value generated by step (g) by a total number of recommended categories and then sum them;
(i) divide the total number of distinct food items by Y, where Y is a nutrient profile for each food item;
(j) multiply the value in step (h) by the value in step (i);
(k) determine the values for F, P, and C and determine the value of (F+P=C/3);
(l) multiply the value generated in step (k) by the value generated in step (j);
(m) multiply the value generated in step (l) by the value generated in step (g);
(n) multiply the value generated in step (m) by the value generated in step (c);
(o) set the value generated in step 14 to be ONQI_{tds} where tds stands for total diet score; and
(p) multiply the value generated in step (o) by a calorie adjustment when available to generate a calorie adjusted total diet score (caONQI_{tds}).

13. The method of claim 1, further comprising adjusting said overall diet score over time as more entries about calorie intake are made.

14. The method of claim 1, further comprising comparing the overall diet score for the diet being evaluated with an overall diet score for another diet.

15. A system for scoring a diet comprising:
a computer, a database, an input device and a display device;
at least one of said computer and said database containing information about a plurality of individual foods forming the diet being evaluated;
said computer being provided with means for evaluating said diet by measuring the quality of the individual foods forming the diet and for compiling scores for each of said measured individual foods to generate an overall score for said diet; and
means for providing information about overall healthiness of said diet being evaluated.

16. The system of claim 15, further comprising:
said input device being used to input personal information about said individual into at least one of a computer and a database;
said computer being provided with means for determining calorie needs for said individual for a given time period;
said computer being provided with means for determining a total number of calories consumed by said individual for said given time period;
said computer being provided with means for determining a total recommended calories for said individual for said given time period;
at least one of said computer and said database containing caloric information including said determined calorie needs, said determined total number of calories, and said determined total recommend calories.

17. The system of claim 16, wherein said personal information comprises information about at least one of age, sex, body mass index, and activity level of said individual.

18. The system of claim 15, wherein said display device provides said individual with said overall diet score and generates tailored messages for improving the individual's diet so as to raise the overall diet score.

19. The system of claim 15, wherein said individual can access said system using at least one of a user computer and a PDA device.

20. The system of claim 15, further comprising means for providing said overall diet score to a health care professional so that said health care professional can counsel said individual on a desired health program.

21. The system of claim 15, wherein said overall diet score is saved to said database.

22. The system of claim 15, wherein said means for evaluating the overall diet score comprises said computer being programmed to use the following equation:
MEAN_{ONQI}*[Σ{(FC₁₋ᵢ servings/tkcal)/(Rfcᵢ servings/2000kcal)}]*[Σ{(FC₁₋ᵢ servings/Rfc₁₋ᵢ servings)/i}*(N/Yi)*(F+P+C/3)]*R_{tkcal}/T_{cal},
where T_{kcal}=total calories consumed;
where R_{kcal}=total recommended calories for age, sex, BMI, and activity level;
where if R_{tkcal}/T_{kcal}>1.33, one lets R_{tkcal}/T_{kcal} (T_{kcal}/R_{tkcal});
where Mean ONQI is the average of ONQI scores for individual foods weighted by number of servings;
where F refers to fat calories;
where P refers to protein calories;
where C refers to carbohydrate calories
where FC refers to a food category;
where FC₁₋ᵢ servings equals the total number of food servings in a given food category 1 through i;
where Rfcᵢ is the recommended servings of a given food category per 2000 kcal and i refers to any given food category;
where i may range from 1-10; and
where Yᵢ refers to a nutrient profile for a given food.

23. The system of claim 15, wherein said means for evaluating said diet comprises said computer being programmed to perform the following steps:
(a) obtaining nutrient information for an individual food/dish and inputting said nutrient information into said computer;
(b) generating a standard ONQI score for each individual food/dish;
(c) determining a mean ONQI score for total food items;
(d) assigning each serving of any food item or dish to at least one category in a dietary guideline for which a minimum recommended intake in servings per day is provided;
(e) determining the total number of servings of food items in said at least one category;
(f) for each said at least one category, dividing a total number of servings by a total cumulative calorie intake and then dividing that by the recommended servings of said at least one category over 2000 kcal;
(g) repeat step (f) for each said at least one food category;
(h) for each per category value generated in step (g), divide a value generated by step (g) by a total number of recommended categories and then sum them;
(i) divide the total number of distinct food items by Y, where Y is a nutrient profile for each food item;
(j) multiply the value in step (h) by the value in step (i);
(k) determine the values for F, P, and C and determine the value of (F+P=C/3);
(l) multiply the value generated in step (k) by the value generated in step (j);
(m) multiply the value generated in step (l) by the value generated in step (g);
(n) multiply the value generated in step (m) by the value generated in step (c);
(o) set the value generated in step 14 to be ONQI_{tds} where tds stands for total diet score; and
(p) multiply the value generated in step (o) by a calorie adjustment when available to generate a calorie adjusted total diet score (caONQI_{tds}).
